(19) United States
(12) Patent Application Publication
(10) Pub. No.: US 2010/0324911 A1
(43) Pub. Date: Dec. 23, 2010

(54) CVSD DECODER STATE UPDATE AFTER PACKET LOSS

(75) Inventors: Mickael Jougit, Mougins Le Haut (FR); Laurent Pilati, Antibes (FR); Mohammad Zad-Issa, Irvine, CA (US)

Correspondence Address: FIALA & WEAVER P.L.L.C.;C/O CPA GLOBAL, P.O. BOX 52050, MINNEAPOLIS, MN, 55402, US

(73) Assignee: BROADCOM CORPORATION, Irvine, CA (US)

(21) Appl. No.: 12/098,561

(22) Filed: Apr. 7, 2008

(51) Int. Cl. G10L 21/00

(52) U.S. Cl. 704/500; 704/E21.001

(57) ABSTRACT

A system and method is described for updating the state of an audio decoder, such as a CVSD decoder, after a packet loss has occurred. In response to the loss of a packet, the system and method encodes audio samples produced by a packet loss concealment (PLC) algorithm and effectively passes the encoded audio samples through the audio decoder in lieu of the contents of the lost packet. This operation brings the state of the audio decoder into better synchronization with the state of a remote audio encoder, thereby reducing or minimizing the degrading effect of the packet loss on the perceived quality of an output audio signal produced by a voice processing system that includes the audio decoder.

### BACKGROUND OF THE INVENTION

1. Field of the Invention

The invention generally relates to communication systems in which information representative of an audio signal is wirelessly transmitted between entities and in which audio data compression/decompression techniques are used to reduce the amount of information needed to represent the audio signal.

2. Background

In many communication systems in which data representative of an audio signal is wirelessly transmitted between entities, audio data compression is used to reduce the amount of data that must be transmitted over the wireless link, thereby conserving bandwidth. Audio data compression uses methods such as coding, pattern recognition and linear prediction to reduce the amount of information used to describe the audio signal. Speech coding is a particular type of audio data compression that is especially adapted for compressing audio signals containing human speech.

One type of speech coding known in the art is termed Continuously Variable Slope Delta Modulation (CVSD). CVSD is a delta modulation technique with a variable step size that was first proposed by J. A. Greefkes and K. Riemens in “Code Modulation with Digitally Controlled Companding for Speech Transmission,” Philips Tech. Rev., pp. 335-353 (1970), the entirety of which is incorporated by reference herein. CVSD encodes at 1 bit per sample, so that audio sampled at 16 kilohertz (kHz) is encoded at 16 kilobits/second (kbit/s).

In CVSD, the encoder maintains a reference sample and a step size. Each input sample is compared to the reference sample. If the input sample is larger, the encoder emits a 1 bit and adds the step size to the reference sample. If the input sample is smaller, the encoder emits a 0 bit and subtracts the step size from the reference sample. The CVSD encoder also keeps the previous K bits of output (K=3 or K=4 are very common) to determine adjustments to the step size; if J of the previous K bits are all 1s or 0s (J=3 or J=4 are also common), the step size is increased by a fixed amount. Otherwise, the step size remains the same (although it may be multiplied by a decay factor which is slightly less than 1). The step size is adjusted for every input sample processed.

A CVSD decoder reverses this process, starting with the reference sample, and adding or subtracting the step size according to the bit stream. The sequence of adjusted reference samples constitutes the reconstructed audio waveform, and the step size is increased or maintained in accordance with the same all-1s-or-0s logic as in the CVSD encoder.

In CVSD, the adaptation of the step size helps to minimize the occurrence of slope overload and granular noise. Slope overload occurs when the slope of the audio signal is so steep that the encoder cannot keep up. Adaptation of the step size in CVSD helps to minimize or prevent this effect by enlarging the step size sufficiently. Granular noise occurs when the audio signal is constant. A CVSD system has no symbols to represent steady state, so a constant input is represented by alternate ones and zeros. Accordingly, the effect of granular noise is minimized when the step size is sufficiently small.

CVSD has been referred to as a compromise between simplicity, low bit rate, and quality. Different forms of CVSD are currently used in a variety of applications. For example, a 12 kbit/s version of CVSD is used in the SECURENET® line of digitally encrypted two-way radio products produced by Motorola, Inc. of Schaumburg, Ill. A 16 kbit/s version of CVSD is used by military digital telephones (referred to as Digital Non-Secure Voice Terminals (DNVT) and Digital Secure Voice Terminals (DSVT)) for use in deployed areas to provide voice recognition quality audio. The Bluetooth™ specifications for wireless personal area networks (PANs) specify a 64 kbit/s version of CVSD that may be used to encode voice signals in telephony-related Bluetooth™ service profiles, e.g. between mobile phones and wireless headsets.

Because CVSD is a type of differential waveform coder, the quality of its performance depends on the maintenance of synchronized state (or history) information at the encoder and the decoder. In a wireless communication system that uses CVSD, packets of encoded audio samples may be lost due to impairments on the wireless link between the CVSD encoder and the CVSD decoder. In certain systems, the loss of a packet will result in the CVSD decoder receiving an empty packet from the physical layer (PHY) interface to the wireless link. Although a technique termed packet loss concealment (PLC) can be used to regenerate the lost packet, the processing of the empty packet by the CVSD decoder will result in a divergence between the state of the CVSD decoder and the state of the CVSD encoder. As a result, good packets subsequently received by the CVSD decoder will not be properly decoded and the perceived quality of the voice signal output by the decoder will be degraded.

This phenomenon is illustrated in reference to graph 100 of FIG. 1. In particular, graph 100 depicts a decoded speech signal 102 produced by the decoding of a CVSD-encoded signal in the absence of packet loss. Also overlaid on graph 100 is a decoded speech signal 104 produced by the decoding of an impaired version of the same CVSD-encoded signal, where the impairment is due to packet loss. As shown in graph 100, during the period of packet loss, decoded speech signal 104 deviates from decoded speech signal 102. This is due to the fact that, during this period, the CVSD decoder is decoding a series of zero bits (representative of one or more “empty packets”) instead of the lost packet(s). As further shown in graph 100, after the period of packet loss has ended, some additional recovery time must pass before decoded signal 104 begins tracking decoded signal 102 again. This recovery period represents the amount of time necessary for the states of the CVSD encoder and CVSD decoder, which have diverged due to the packet loss, to converge again.

What is needed then is a technique that reduces the adverse effect on the perceived quality of a decoded speech signal produced by a CVSD decoder due to packet loss. In particular, a technique is needed to address the divergence between the state of a CVSD encoder and a CVSD decoder that occurs due to the loss of one or more packets of encoded audio data transmitted from the CVSD encoder to the CVSD decoder.

### BRIEF SUMMARY OF THE INVENTION

A system and method is described herein for updating the state of an audio decoder, such as a CVSD decoder, after a packet loss has occurred. In response to the loss of a packet, the system and method encodes audio samples produced by a packet loss concealment (PLC) algorithm and effectively passes the encoded audio samples through the audio decoder in lieu of the contents of the lost packet. This operation brings the state of the audio decoder into better synchronization with the state of a remote audio encoder, thereby reducing or minimizing the degrading effect of the packet loss on the perceived quality of an output audio signal produced by a voice processing system that includes the audio decoder.

In particular, a method is described herein for updating the state of an audio decoder, such as a Continuously Variable Slope Delta Modulation (CVSD) decoder. In accordance with the method, information representative of a state of the audio decoder is stored after decoding of a first series of encoded audio samples by the audio decoder. Such information may include one or more of a reconstructed speech sample, a plurality of encoded output bits, or a step size. A first series of audio samples generated by packet loss concealment (PLC) logic is received. The state of an audio encoder, such as a CVSD encoder, is set based on the stored information. The first series of audio samples is then encoded by the audio encoder to generate a second series of encoded audio samples. The second series of encoded audio samples is provided to the audio decoder for decoding, wherein the decoding of the second series of encoded audio samples by the audio decoder results in an updating of the state of the audio decoder.

The foregoing method may further include over-writing information representative of a current state of the audio decoder with the stored information prior to providing the second series of encoded audio samples to the audio decoder for decoding. The foregoing method may also include decoding the second series of encoded audio samples by the decoder to generate a second series of audio samples and processing the second series of audio samples for play back to a user.

An audio processing system is also described herein. The audio processing system includes an audio decoder, such as a CVSD decoder, PLC logic connected to the audio decoder, and decoder state update logic connected to the audio decoder and the PLC logic. The decoder state update logic includes decoder state tracking logic, control logic, and an audio encoder, such as a CVSD encoder. The decoder state tracking logic is configured to store information representative of a state of the audio decoder after decoding of a first series of encoded audio samples by the audio decoder. Such information may include one or more of a reconstructed speech sample, a plurality of encoded output bits, or a step size. The control logic is configured to receive a first series of audio samples generated by the PLC logic and to establish an audio encoder state based on the stored information. The audio encoder configured to encode the first series of audio samples in accordance with the audio encoder state to generate a second series of encoded audio samples and to provide the second series of encoded audio samples to the audio decoder for decoding, wherein the decoding of the second series of encoded audio samples by the audio decoder results in an updating of the state of the audio decoder.

The foregoing audio processing system may further include decoder state over-write logic. The decoder state over-write logic is configured to over-write information representative of a current state of the audio decoder with the stored information prior to the provision of the second series of encoded audio samples to the audio decoder for decoding.

In one implementation of the foregoing audio processing system, the audio decoder is further configured to decode the second series of encoded audio samples to generate a second series of audio samples and the audio processing system further includes logic configured to process the second series of audio samples for play back to a user.

A computer program product is also described herein. The computer program product comprises a computer-readable medium having computer program logic recorded thereon. The computer program logic includes first means, second means, third means, fourth means and fifth means. The first means are for enabling a processing unit to store information representative of an audio decoder state after decoding of a first series of encoded audio samples. Such information may include one or more of a reconstructed speech sample, a plurality of encoded output bits, or a step size. The second means are for enabling the processing unit to receive a first series of audio samples generated by packet loss concealment logic. The third means are for enabling the processing unit to set an audio encoder state based on the stored information. The fourth means are for enabling the processing unit to encode the first series of audio samples in accordance with the audio encoder state to generate a second series of encoded audio samples. The fifth means are for enabling the processing unit to decode the second series of encoded audio samples, wherein the decoding of the second series of encoded audio samples by the audio decoder results in the updating of the audio decoder state.

In one implementation of the foregoing computer program product, the first means comprises means for enabling the processing unit to store information representative of the audio decoder state after CVSD decoding of the first series of encoded audio samples audio and the fourth means comprises means for enabling the processing unit to CVSD encode the first series of audio samples in accordance with the audio encoder state to generate the second series of encoded audio samples.

In a further implementation of the foregoing computer program product, the computer program logic may further include means for enabling the processing unit to over-write information representative of a current audio decoder state with the stored information prior to the decoding of the second series of encoded audio samples.

In a still further implementation of the foregoing computer program product, the fifth means includes means for enabling the processing unit to decode the second series of encoded audio samples to generate a second series of audio samples and the computer program logic further includes means for enabling the processing unit to process the second series of audio samples for play back to a user.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a graph that illustrates the impact of packet loss on the decoding of a speech signal encoded in accordance with a Continuously Variable Slope Delta Modulation (CVSD) technique.

FIG. 2 is a block diagram of a voice processing system in accordance with an embodiment of the present invention.

FIG. 3 is a block diagram of a CVSD encoder that may be used in the voice processing system of FIG. 2.

FIG. 4 is a block diagram of a CVSD decoder that may be used in the voice processing system of FIG. 2.

FIG. 5 is a block diagram of an accumulator that may be used to implement the CVSD encoder of FIG. 3 or the CVSD decoder of FIG. 4.

FIG. 6 is a block diagram of decoder state update logic that may be used in the voice processing system of FIG. 2.

FIG. 7 depicts a flowchart of a method for performing CVSD decoding in a voice processing system in accordance with an embodiment of the present invention.

FIG. 8 is a block diagram of a computer system that may be used to implement aspects of the present invention.

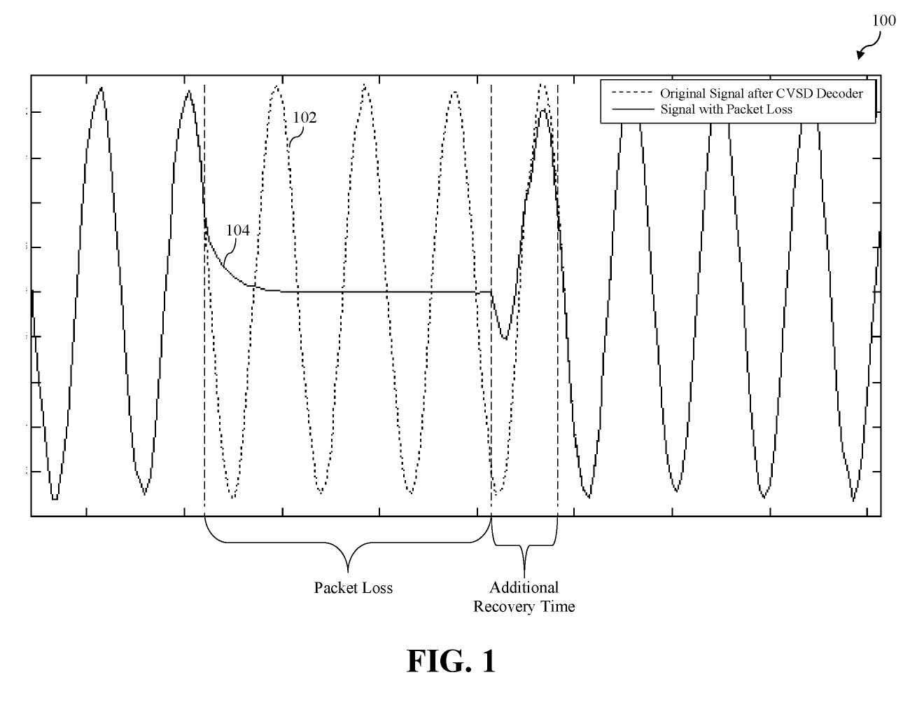

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION OF THE INVENTION

### A. Example Voice Processing System in Accordance with an Embodiment of the Present Invention

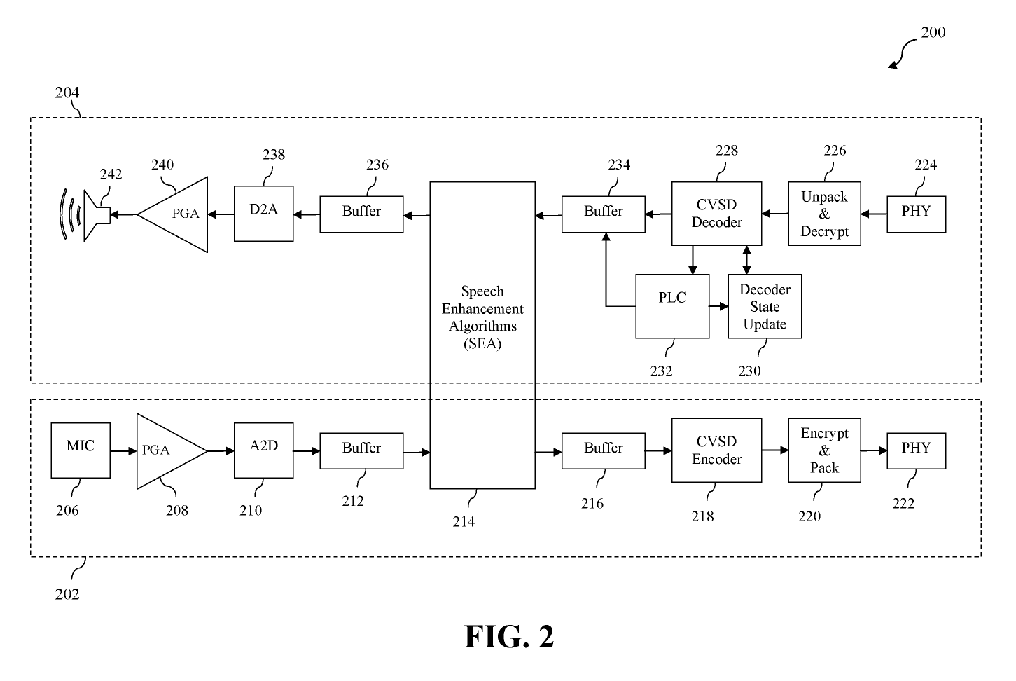

FIG. 2 is a block diagram of an example voice processing system 200 in which an embodiment of the present invention may be implemented. Voice processing system 200 is an integrated part of a Bluetooth™ headset. As shown in FIG. 2, voice processing system 200 includes a transmit path 202 and a receive path 204. Transmit path 202 is adapted to receive an input speech signal from a user and to generate information representative of that signal for wireless transmission to a Bluetooth™-enabled cellular telephone. Such transmission may occur, for example, over a bidirectional Synchronous Connection Oriented (SCO) link. Receive path 204 is adapted to receive information that was wirelessly transmitted from the Bluetooth™-enabled cellular telephone and to generate an output speech signal therefrom for playback to the user. The elements of transmit path 202 and receive path 204 will now be described in more detail.

As shown in FIG. 2, transmit path 202 includes a microphone 206. Microphone 206 is an acoustic-to-electric transducer that operates in a well-known manner to convert sound waves associated with a user's speech into an analog speech signal. A programmable gain amplifier (PGA) 208 is connected to microphone 206 and is configured to amplify the analog speech signal produced by microphone 208 to generate an amplified analog speech signal. An analog-to-digital (A2D) converter 210 is connected to PGA 210 and is adapted to convert the amplified analog speech signal produced by PGA 210 into a series of digital speech samples. The digital speech samples produced by A2D converter 210 are temporarily stored in a buffer 212 pending processing by speech enhancement algorithms (SEA) 214.

SEA 214 are configured to process the digital speech samples stored in buffer 212 in a manner that tends to improve the quality and intelligibility of the speech signal represented by those samples. For example, depending upon the implementation, SEA 214 may include any of a variety of noise reduction and echo cancellation algorithms. After SEA 214 has processed a digital sample, the sample is temporarily stored in another buffer 216 pending processing by a Continuously Variable Slope Delta Modulation (CVSD) encoder 218.

CVSD encoder 218 is connected to buffer 216 and is configured to receive a series of digital speech samples therefrom and to compress each digital speech sample in the series in accordance with a CVSD encoding technique. This encoding produces a single bit representation of each digital speech sample. The manner in which CVSD encoder 218 operates to perform this function will be described in more detail below. Encryption and packing logic 220 is connected to CVSD encoder 218 and is configured to encrypt and pack the encoded samples produced by CVSD encoder into packets. Each packet generated by encryption and packing logic 220 may include a fixed number of encoded speech samples. The packets produced by encryption and packing logic 220 are provided to a physical layer (PHY) interface 222 for subsequent transmission to a Bluetooth™-enabled cellular telephone over a wireless link.

As further shown in FIG. 2, receive path 204 also includes a PHY interface 224. PHY interface 224 is configured to deliver packets received over a wireless link from a Bluetooth™-enabled cellular telephone to decryption and unpacking logic 226. Decryption and unpacking logic 226 is configured to unpack and decrypt the packets received from PHY interface 224 to produce a series of encoded speech samples. CVSD decoder 228 is connected to unpacking and decryption logic 226 and is configured to decode each of the encoded speech samples in the series to produce a corresponding digital speech sample. The manner in which CVSD decoder 228 operates to perform this function will be described in more detail below.

Receive path 204 further includes packet loss concealment (PLC) logic 232 that is configured to detect when one or more packets transmitted from a Bluetooth™-enabled cellular telephone have been lost. PLC logic 232 is further configured to perform operations to synthesize a series of digital speech samples to replace the digital speech samples that would have otherwise been produced through the CVSD decoding of the lost packet(s). A variety of PLC techniques are known in the art for performing this function. Many of these techniques use some form of time or frequency extrapolation of the decoded speech waveform preceding the waveform represented by the lost packet(s) to generate replacement samples. In implementations where subsequently-received speech samples are available (e.g., through the introduction of a look-ahead delay), some form of time or frequency interpolation of the decoded speech waveform preceding and following the waveform represented by the lost packet(s) may be used.

As further shown in FIG. 2, receive path 204 also includes decoder state update logic 230 that is connected to CVSD decoder 228 and PLC logic 232. Decoder state update logic 230 is configured to update the state of CVSD decoder 228 after a packet loss has occurred and immediately prior to the decoding of good packets (i.e., packets that have not been lost in transmission) by CVSD decoder 228. In particular, decoder state update logic 230 is advantageously configured to perform operations that will bring the state of CVSD decoder 228 into better synchronization with the state of a remote CVSD encoder after packet loss. This has the beneficial effect of minimizing the degrading effect of packet loss on the perceived quality of the output speech signal produced by voice processing system 200. The manner in which decoder state update logic 230 performs this function will be described in more detail below.

Digital speech samples produced by CVSD decoder 228 and PLC logic 232 are temporarily stored in a buffer 234 pending processing by SEA 214. SEA 214 is configured to process the digital speech samples stored in buffer 234 in a manner that tends to improve the quality and intelligibility of the speech signal represented by those samples. After processing by SEA 214, the digital speech samples are temporarily stored in another buffer 236.

A digital-to-analog (D2A) converter 238 is connected to buffer 236 and is adapted to convert a series of digital speech samples received from buffer 236 into an analog speech signal. A PGA 240 is connected to D2A converter 238 and is configured to amplify the analog speech signal produced by D2A converter 238 to generate an amplified analog speech signal. A speaker 242 comprising an electromechanical transducer is connected to PGA 240 and operates in a well-known manner to convert the amplified analog audio signal into sound waves for perception by a user.

Although the foregoing described a voice processing system in a Bluetooth™ headset in which an embodiment of the present invention is implemented, the present invention is not limited to a particular operating environment or to the processing of speech only. Rather, persons skilled in the relevant art(s), based on the teachings provided herein, will readily appreciate that the invention may be practiced in any system or device that performs CVSD decoding of an encoded audio signal.

1. Example CVSD Encoder and Decoder

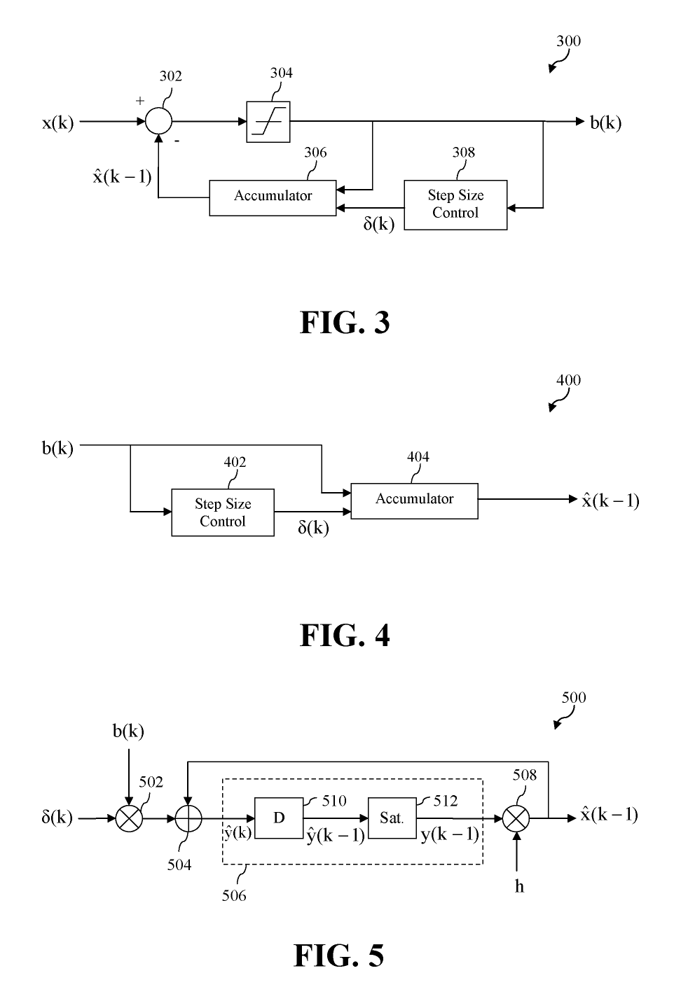

Example implementations of a CVSD encoder 218 and CVSD decoder 228 of voice processing system 200 will now be described. In particular, FIG. 3 is a functional block diagram of a CVSD encoder 300 that may be used to implement CVSD encoder 218 of voice processing system 200. As shown in FIG. 3, the input to CVSD encoder 300 is a speech sample x(k), which is the k^{th} sample in a series of input speech samples denoted x. In one implementation, the input speech samples provided to CVSD encoder 300 are linear pulse code modulated (PCM) samples obtained at a 64 kilosamples/second (ksamples/s) sampling rate. CVSD encoder 300 may be clocked at 64 kilohertz (kHz).

As shown in FIG. 3, a subtractor 302 is configured to subtract a reconstructed version of the previous input speech sample, denoted \hat{x}(k−1), from input speech sample x(k). A logic block 304 is configured to apply a sign function to the difference to derive an output bit b(k). The sign function is defined such that:

$$sgn ( x ) = \{ \begin{matrix}1 , & for x \geq 0 , \\ - 1 , & otherwise .\end{matrix}$$

Thus, if input speech sample x(k) is larger than reconstructed sample \hat{x}(k−1), then the value of b(k) will be 1; otherwise the value of b(k) will be −1. In one implementation, when b(k) is transmitted on the air, it is represented by a sign bit such that negative numbers are mapped on “1” and positive numbers are mapped on “0”.

Step size control block 308 is configured to determine a step size associated with the current input speech sample, denoted δ(k). To determine δ(k), step size control block 308 is configured to first determine the value of a syllabic companding parameter, denoted α. The syllabic companding parameter α is determined as follows:

$$α = \{ \begin{matrix}1 , & if J bits in the last K output bits are equal , \\ 0 , & otherwise .\end{matrix}$$

In one implementation, the parameter J=4 and the parameter K=4. Based on the value of the syllabic companding parameter α, step size control block 308 is configured to determine the step size δ(k) in accordance with:

$$δ ( k ) = \{ \begin{matrix}min ( δ ( k - 1 ) + {δ}_{min} , {δ}_{max} ) , & α = 1 , \\ max ( βδ ( k - 1 ) , {δ}_{min} ) , & α = 0 ,\end{matrix}$$

wherein δ(k−1) is the step size associated with the previous input speech sample, δₘᵢₙ is the minimum step size, δₘₐₓ is the maximum step size, and β is the decay factor for the step size. In one implementation, δₘᵢₙ=10,

$${δ}_{max} = 1280 and β = 1 - \frac{1}{1024} .$$

As further shown in FIG. 3, an accumulator 306 is configured to receive output bit b(k) and step size δ(k) and to generate the reconstructed version of the previous input speech sample \hat{x}(k−1) therefrom. FIG. 5 is a block diagram 500 that shows how accumulator 306 operates to perform this function. In particular, as shown in FIG. 5, a first multiplier 502 and an adder 504 are configured to calculate a value ŷ(k) in accordance with:

ŷ(k)=\hat{x}(k−1)+b(k)δ(k).

A delay block 510 is configured to introduce one clock cycle of delay such that ŷ(k) may now be represented as ŷ(k−1). A logic block 512 is configured to apply a saturation function to ŷ(k−1) to generate accumulator contents y(k−1). The saturation function is defined as:

$$y ( k ) = \{ \begin{matrix}min ( \hat{y} ( k ) , {y}_{max} ) , & \hat{y} ( k ) \geq 0 \\ max ( \hat{y} ( k ) , {y}_{min} ) , & \hat{y} ( k ) < 0 ,\end{matrix}$$

wherein yₘᵢₙ and yₘₐₓ are the accumulator's negative and positive saturation values, respectively. In some implementations, the parameter yₘᵢₙ is set to −2¹⁵ or −2¹⁵+1 and the parameter yₘₐₓ is set to 2¹⁵⁻1. Finally, a second multiplier 508 is configured to multiply ŷ(k−1) by the delay factor for the accumulator, denoted h, to produce the reconstructed version of the previous input speech sample \hat{x}(k−1). In some implementations,

$$h = 1 - \frac{1}{32} .$$

FIG. 4 is a functional block diagram of a CVSD decoder 400 that may be used to implement CVSD decoder 228 of voice processing system 200. As shown in FIG. 4, the input to CVSD decoder 400 is an input bit b(k) and the output is the reconstructed version of the previous speech sample \hat{x}(k−1). CVSD decoder 400 essentially reverses the encoding process applied by CVSD encoder 300 by adding or subtracting the step size δ(k) to a previously reconstructed speech sample according to the value of input bit b(k). As shown in FIG. 4, CVSD decoder 402 includes a step size control block 402 that is configured to operate in a like manner to step size control block 308 of CVSD encoder 300 and an accumulator 404 that is configured to operate in a like manner to accumulator 306 of CVSD encoder 300 of FIG. 3. Like CVSD encoder 300, CVSD decoder 400 may be clocked at 64 kilohertz (kHz).

As can be seen from the foregoing, the proper performance of CVSD encoder 300 and CVSD decoder 400 is dependent upon the synchronized maintenance by both entities of certain state information. This state information includes, for example, the reconstructed version of the previous speech sample \hat{x}(k−1), the four previous output bits b(k−1), b(k−2), b(k−3) and b(k−4) needed to determine the current value of the syllabic companding parameter α, and the step size corresponding to the previous speech sample δ(k−1).

2. Example CVSD Decoder State Update Logic

As noted above, voice processing system 200 includes decoder state update logic 230 that is configured to update the state of CVSD decoder 228 after a packet loss has occurred to bring the state of CVSD decoder 228 into better synchronization with the state of a remote CVSD encoder. This has the beneficial effect of reducing the degrading effect of packet loss on the perceived quality of the output speech signal produced by voice processing system 200.

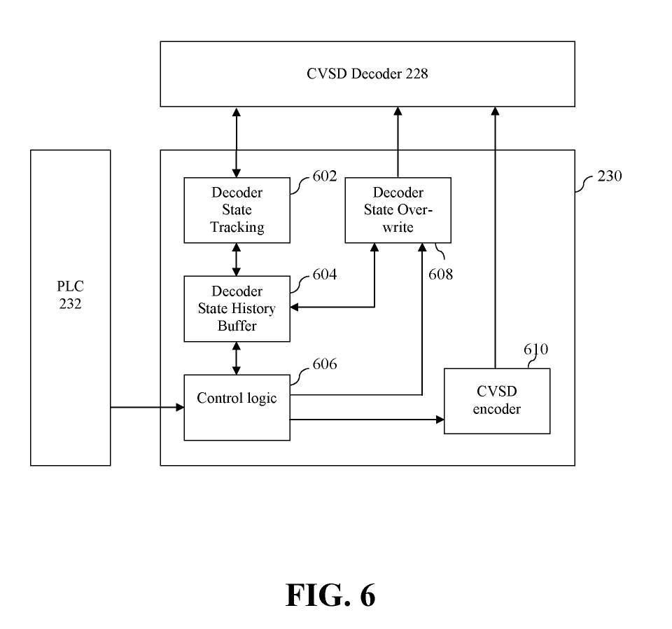

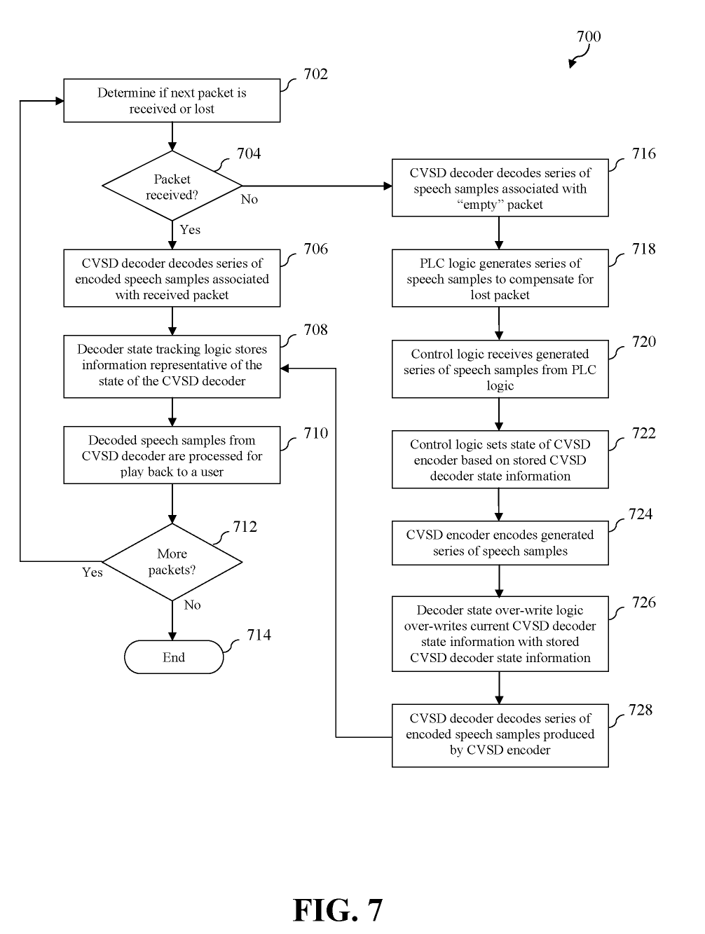

FIG. 6 is a block diagram of one implementation of decoder state update logic 230. As shown in FIG. 6, decoder state update logic 230 includes a number of communicatively connected elements including decoder state tracking logic 602, a decoder state history buffer 604, control logic 606, decoder state over-write logic 608 and a CVSD encoder 610. It is to be understood that, depending upon the implementation, certain of these elements may be implemented in hardware using analog and/or digital circuits, in software, through the execution of instructions by one or more general purpose or special-purpose processors, or as a combination of hardware and software. The manner in which each of these elements operates to perform features of the present invention will now be described in reference to flowchart 700 of FIG. 7.

In particular, FIG. 7 depicts a flowchart 700 of a method for performing CVSD decoding in a voice processing system in accordance with an embodiment of the present invention. The method of flowchart 700 includes steps for updating the state of a CVSD decoder after packet loss to bring the state of the CVSD decoder into better synchronization with the state of a remote CVSD encoder. The steps of flowchart 700 will now be described with continued reference to elements of voice processing system 200 as described above in reference to FIG. 2 and elements of decoder state update logic 600 as described above in reference to FIG. 6; however, the method is not limited to those implementations.

The method of flowchart 700 begins at step 702, in which CVSD decoder 228 determines if the next packet of encoded speech samples in a series of packets to be processed has been received or lost. If the packet has been received, then CVSD decoder 228 decodes the series of encoded speech samples associated with the received packet as shown at decision step 704 and step 706. After CVSD decoder 228 has decoded the series of encoded speech samples associated with the received packet, decoder state tracking logic 602 stores information representative of the state of CVSD decoder 228 in decoder state history buffer 604 as shown at step 708. As discussed above in Section A.1, such information may include, for example, a reconstructed version of the previous speech sample \hat{x}(k−1), the four previous encoded output bits b(k−1), b(k−2), b(k−3) and b(k−4) needed to determine the current value of the syllabic companding parameter α, and the step size corresponding to the previous speech sample δ(k−1).

The decoded speech samples produced by CVSD decoder 228 are then processed by other elements in receive path 204 of voice processing system 200 for play back to a user as shown at step 710. At decision step 712, it is determined whether more packets of encoded speech samples are to be processed. If no more packets are to be processed, then the method ends as shown at step 714. If there are more packets to be processed, then control returns to step 702.

Returning now to decision step 704, if it is determined during that step that the next packet to be processed has been lost, then CVSD decoder receives an empty packet from PHY interface 224 and decodes a series of speech samples associated with the empty packet. The series of speech samples associated with the empty packet may be, for example, a series of zero bits.

At step 718, PLC logic 232 generates a series of speech samples to compensate for the lost packet. The generated series of speech samples are an approximation of the speech samples that would have been produced by CVSD decoder 228 if the lost packet had actually been received. As noted above, there are a wide variety of PLC algorithms known in the art that may be used to perform this step.

At step 720, control logic 606 receives the generated series of speech samples from PLC logic 232. At step 722, control logic 606 sets the state of CVSD encoder 610 based on CVSD decoder state information stored in decoder state history buffer 604. This CVSD decoder state information represents the state of CVSD decoder 228 after decoding the series of encoded speech samples associated with the previous packet, whether received or lost. As noted above, such state information may include, for example, a reconstructed version of the previous speech sample \hat{x}(k−1), the four previous encoded output bits b(k−1), b(k−2), b(k−3) and b(k−4) needed to determine the current value of the syllabic companding parameter α, and the step size corresponding to the previous speech sample δ(k−1).

At step 724, CVSD encoder 610 encodes the series of speech samples generated by PLC logic 232 based on the state information supplied in step 722 to generate a series of encoded speech samples.

At step 726, decoder state over-write logic 608 over-writes the current state information associated with CVSD decoder 228 with the CVSD decoder information stored in decoder state history buffer 604. As noted above, this CVSD decoder state information represents the state of CVSD decoder 228 after the decoding the series of encoded speech samples associated with the previous packet, whether received or lost.

At step 728, CVSD decoder 228 decodes the series of encoded speech samples produced by CVSD encoder 610 during step 726 to produce a series of decoded speech samples. After CVSD decoder 228 has decoded the series of encoded speech samples produced by CVSD encoder 610, decoder state tracking logic 602 stores new information representative of the state of CVSD decoder 228 in decoder state history buffer 604 as shown at step 708.

The decoded speech samples produced by CVSD decoder 228 are then processed by other elements in receive path 204 of voice processing system 200 for play back to a user as shown at step 710. At decision step 712, it is determined whether more packets of encoded speech samples are to be processed. If no more packets are to be processed, then the method ends as shown at step 714. If there are more packets to be processed, then control returns to step 702.

The foregoing method reduces the degrading effect of packet loss on the perceived quality of the output speech signal produced by voice processing system 200 by encoding speech samples produces by a PLC algorithm in response to the loss of a packet and by effectively passing the encoded speech samples through the CVSD decoder in lieu of the contents of the lost packet. This has the advantageous effect of reducing the amount of divergence between the state of the CVSD decoder and the state of the remote CVSD encoder due to the packet loss.

In accordance with the foregoing method, during packet loss, CVSD decoder 228 decodes an empty packet delivered from PHY interface 224. This is shown at step 716. The processing of the empty packet corrupts the state of CVSD decoder 228. To address this issue, decoder state over-write logic 608 over-writes the state information associated with CVSD decoder 228 with stored state information that reflects that the state of CVSD decoder 228 after processing of the previous packet. This is shown at step 726.

In an alternate embodiment (not shown in FIG. 7), rather than processing an empty packet during packet loss, CVSD decoding may be bypassed entirely. In such an embodiment, the state of CVSD decoder 228 would remain the same as it was at the end of processing the previous packet. Thus, in such an embodiment, there would be no need to over-write the state information associated with the state of CVSD decoder 228 as shown at step 726.

### C. Hardware and Software Implementations

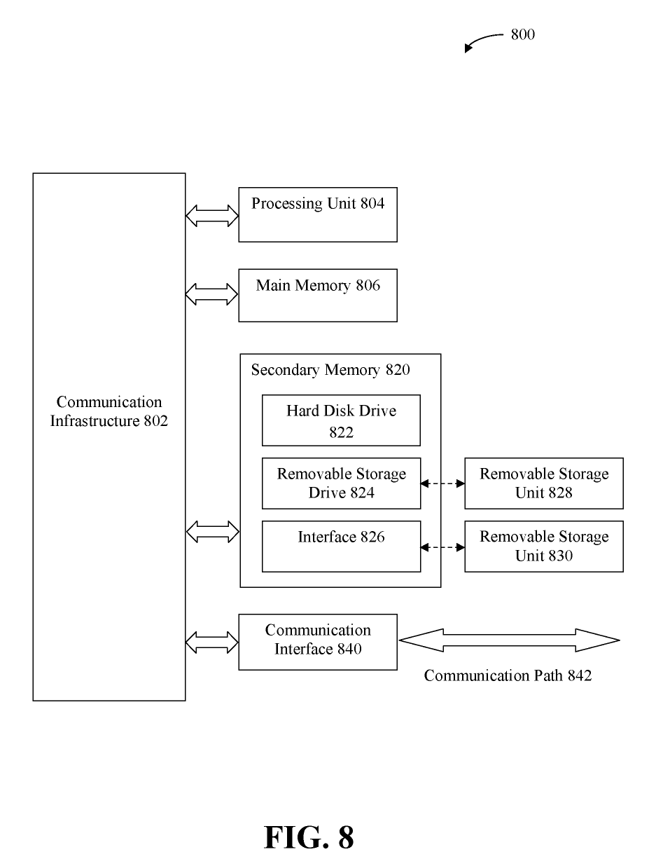

The present invention can be implemented in hardware, in software, or as a combination of hardware and software. Aspects of the present invention that may be implemented in software may be executed on a computer system, such as computer system 800 of FIG. 8. For example, with reference to voice processing system 200 of FIG. 2, each of CVSD decoder 228, PLC logic 232 and decoder state update logic 230 may be implemented in software and executed by computer system 800.

As shown in FIG. 8, computer system 800 includes a processing unit 804 that includes one or more processors. Processor unit 804 is connected to a communication infrastructure 802, which may comprise, for example, a bus or a network.

Computer system 800 also includes a main memory 806, preferably random access memory (RAM), and may also include a secondary memory 820. Secondary memory 820 may include, for example, a hard disk drive 822 and/or a removable storage drive 824, representing a floppy disk drive, a magnetic tape drive, an optical disk drive, or the like. Removable storage drive 824 reads from and/or writes to a removable storage unit 828 in a well known manner. Removable storage unit 828 represents a floppy disk, magnetic tape, optical disk, or the like, which is read by and written to by removable storage drive 824. As will be appreciated by persons skilled in the relevant art(s), removable storage unit 828 includes a computer usable storage medium having stored therein computer software and/or data.

In alternative implementations, secondary memory 820 may include other similar means for allowing computer programs or other instructions to be loaded into computer system 800. Such means may include, for example, a removable storage unit 830 and an interface 826. Examples of such means may include a program cartridge and cartridge interface (such as that found in video game devices), a removable memory chip (such as an EPROM, or PROM) and associated socket, and other removable storage units 830 and interfaces 826 which allow software and data to be transferred from removable storage unit 830 to computer system 800.

Computer system 800 may also include a communications interface 840. Communications interface 840 allows software and data to be transferred between computer system 800 and external devices. Examples of communications interface 840 may include a modem, a network interface (such as an Ethernet card), a communications port, a PCMCIA slot and card, etc. Software and data transferred via communications interface 840 are in the form of signals which may be electronic, electromagnetic, optical, or other signals capable of being received by communications interface 840. These signals are provided to communications interface 840 via a communications path 842. Communications path 842 carries signals and may be implemented using wire or cable, fiber optics, a phone line, a cellular phone link, an RF link and other communications channels.

As used herein, the terms “computer program medium” and “computer readable medium” are used to generally refer to media such as removable storage unit 828, removable storage unit 830 or a hard disk installed in hard disk drive 822. Computer program medium and computer readable medium can also refer to memories, such as main memory 806 and secondary memory 820, which can be semiconductor devices (e.g., DRAMs, etc.). These computer program products are means for providing software to computer system 800.

Computer programs (also called computer control logic, programming logic, or logic) are stored in main memory 806 and/or secondary memory 820. Computer programs may also be received via communications interface 840. Such computer programs, when executed, enable the computer system 800 to implement features of the present invention as discussed herein. Accordingly, such computer programs represent controllers of the computer system 800. Where the invention is implemented using software, the software may be stored in a computer program product and loaded into computer system 800 using removable storage drive 824, interface 826, or communications interface 840.

In another embodiment, features of the invention are implemented primarily in hardware using, for example, hardware components such as application-specific integrated circuits (ASICs) and gate arrays. Implementation of a hardware state machine so as to perform the functions described herein will also be apparent to persons skilled in the relevant art(s).

### D. Conclusion

While various embodiments of the present invention have been described above, it should be understood that they have been presented by way of example only, and not limitation. It will be understood by those skilled in the relevant art(s) that various changes in form and details may be made to the embodiments of the present invention described herein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for updating the state of an audio decoder, comprising:
storing information representative of a state of the audio decoder after decoding of a first series of encoded audio samples by the audio decoder;
receiving a first series of audio samples generated by packet loss concealment logic;
setting the state of an audio encoder based on the stored information;
encoding the first series of audio samples by the audio encoder to generate a second series of encoded audio samples; and
providing the second series of encoded audio samples to the audio decoder for decoding, wherein the decoding of the second series of encoded audio samples by the audio decoder results in an updating of the state of the audio decoder.

2. The method of claim 1, further comprising:
over-writing information representative of a current state of the audio decoder with the stored information prior to providing the second series of encoded audio samples to the audio decoder for decoding.

3. The method of claim 1, wherein the audio decoder comprises a Continuously Variable Slope Delta Modulation (CVSD) decoder and the audio encoder comprises a CVSD encoder.

4. The method of claim 3, wherein storing state information associated with the audio decoder comprises storing one or more of:
a reconstructed speech sample;
a plurality of encoded output bits; or
a step size.

5. The method of claim 1, further comprising:
recovering the first series of encoded audio samples from a packet.

6. The method of claim 1, further comprising:
decoding the second series of encoded audio samples by the decoder to generate a second series of audio samples; and
processing the second series of audio samples for play back to a user.

7. The method of claim 1, further comprising:
storing information representative of the updated state of the audio decoder.

8. An audio processing system, comprising:
an audio decoder;
packet loss concealment (PLC) logic connected to the audio decoder; and
decoder state update logic connected to the audio decoder and the PLC logic, the decoder state update logic comprising:
decoder state tracking logic configured to store information representative of a state of the audio decoder after decoding of a first series of encoded audio samples by the audio decoder,
control logic configured to receive a first series of audio samples generated by the PLC logic and to establish an audio encoder state based on the stored information,
an audio encoder configured to encode the first series of audio samples in accordance with the audio encoder state to generate a second series of encoded audio samples and to provide the second series of encoded audio samples to the audio decoder for decoding, wherein the decoding of the second series of encoded audio samples by the audio decoder results in an updating of the state of the audio decoder.

9. The audio processing system of claim 8, further comprising:
decoder state over-write logic configured to over-write information representative of a current state of the audio decoder with the stored information prior to the provision of the second series of encoded audio samples to the audio decoder for decoding.

10. The audio processing system of claim 8, wherein the audio decoder comprises a Continuously Variable Slope Delta Modulation (CVSD) decoder and the audio encoder comprises a CVSD encoder.

11. The audio processing system of claim 10, wherein the decoder state tracking logic is configured to store one or more of:
a reconstructed speech sample;
a plurality of encoded output bits; or
a step size.

12. The audio processing system of claim 8, further comprising:
unpacking and decryption logic configured to recover the first series of encoded audio samples from a packet.

13. The audio processing system of claim 8, wherein the audio decoder is further configured to decode the second series of encoded audio samples to generate a second series of audio samples and wherein the audio processing system further comprises logic configured to process the second series of audio samples for play back to a user.

14. The audio processing system of claim 8, wherein the decoder state tracking logic is further configured to store information representative of the updated state of the audio decoder.

15. A computer program product comprising a computer-readable medium having computer program logic recorded thereon, the computer program logic comprising:
first means for enabling a processing unit to store information representative of an audio decoder state after decoding of a first series of encoded audio samples;
second means for enabling the processing unit to receive a first series of audio samples generated by packet loss concealment logic;
third means for enabling the processing unit to set an audio encoder state based on the stored information;
fourth means for enabling the processing unit to encode the first series of audio samples in accordance with the audio encoder state to generate a second series of encoded audio samples; and
fifth means for enabling the processing unit to decode the second series of encoded audio samples, wherein the decoding of the second series of encoded audio samples by the audio decoder results in the updating of the audio decoder state.

16. The computer program product of claim 15, wherein the computer program logic further comprises:
means for enabling the processing unit to over-write information representative of a current audio decoder state with the stored information prior to the decoding of the second series of encoded audio samples.

17. The computer program product of claim 15, wherein the first means comprises means for enabling the processing unit to store information representative of the audio decoder state after Continuously Variable Slope Delta Modulation (CVSD) decoding of the first series of encoded audio samples audio, and
wherein the fourth means comprises means for enabling the processing unit to CVSD encode the first series of audio samples in accordance with the audio encoder state to generate the second series of encoded audio samples.

18. The computer program product of claim 17, wherein the first means comprises means for enabling the processing unit to store one or more of:
a reconstructed speech sample;
a plurality of encoded output bits; or
a step size.

19. The computer program product of claim 15, wherein the computer program logic further comprises:
means for enabling the processing unit to recover the first series of encoded audio samples from a packet.

20. The computer program product of claim 15, wherein the fifth means comprises means for enabling the processing unit to decode the second series of encoded audio samples to generate a second series of audio samples, wherein the computer program logic further comprises:
means for enabling the processing unit to process the second series of audio samples for play back to a user.

21. The computer program product of claim 15, wherein the first means further comprises means for enabling the processing unit to store information representative of the updated audio decoder state.
